(19) United States
(12) Patent Application Publication
(10) Pub. No.: US 2003/0081709 A1
(43) Pub. Date: May 1, 2003

(54) Single-ended IO with dynamic synchronous deskewing architecture

(75) Inventors: Hiep P. Ngo, Boston, MA (US); William B. Gist, Chelmsford, MA (US); Federico Tandeter, Cambridge, MA (US); Todd A. Hinck, Cambridge, MA (US)

Correspondence Address: LAHIVE & COCKFIELD, 28 STATE STREET, BOSTON, MA, 02109, US

(73) Assignee: Sun Microsystems, Inc., Palo Alto, CA

(21) Appl. No.: 10/016,196

(22) Filed: Oct. 30, 2001

(51) Int. Cl. H04L 7/04

(52) U.S. Cl. 375/362

(57) ABSTRACT

A synchronous interconnect structure is provided for transmitting and receiving source synchronous signals. The receiver of the synchronous interconnect structure continuously monitors the phase relationship between the source clock signal and each transmitted data signal. In this manner, the synchronous interconnect structure can perform signal timing alignment for each transmitted clock and data signal in near real time fashion without impacting data transmission rates across the synchronous interconnect structure.

### TECHNICAL FIELD OF THE INVENTION

The present invention generally relates to integrated circuits, and more particularly, to an integrated circuit having a synchronous interconnect structure.

### BACKGROUND OF THE INVENTION

As integrated circuit fabrication technology advances, integrated circuits are becoming smaller, faster and more complex. Nevertheless, the technological advances in communication mediums, such as printed circuit board interconnections have not advanced at the same pace. Consequently, the speed at which newly fabricated integrated circuits transmit and receive data has surpassed the transmission capabilities of printed circuit board interconnections, especially in a multiprocessor interconnection network. To compensate for the limited bandwidth of a single transmission line carrying multiple bits of data over a printed circuit interconnection, design engineers and system architects have begun to establish the use of parallel transmission lines, also known as synchronous point to point transmission lines.

Unlike serially transmitted bytes of data that typically include timing information for each bit, synchronous point to point communications require the transmitting circuit device to provide a source synchronous clock signal for timing purposes by the receiving circuit. The source synchronous clock signal typically has a pre-determined phase relationship to the parallelly transmitted data. Unfortunately, phase discrepancies between the source synchronous clock signal and one or more of the parallel data signals can occur during transmission and cause the receiving electronic device to misrepresent a received data bit.

Typically, the receiving device includes a timing recovery circuit that compensates for the time delay that occurs on each transmission line. Unfortunately, the timing recovery circuit provides a fixed constant to compensate for the data signal time delay on a particular transmission line that is determined during an initial open loop calibration step or during a selected time period in which the timing recovery circuit is allowed to update the fixed timing recovery constant. However, the conventional timing recovery circuit cannot dynamically compensate for data and clock signal shifts that occur during data transmission caused by dynamic events, such as cross talk, electromagnetic interference, power supply noise or variations in transmission line capacitance and inductance due to transmission line loading.

### SUMMARY OF THE INVENTION

The present invention addresses the above-identified limitations of conventional synchronous interconnect structures coupled between two or more integrated circuits. The present invention provides an approach to compensate for the timing alignment amongst one or more data or clock signals traveling from a first integrated circuit to a second integrated circuit via a transmission line, such as a printed circuit board trace in real time fashion.

In one embodiment of the present invention, a system is provided for synchronous communication between a first integrated circuit and a second integrated circuit mounted to a printed circuit board. The system includes a synchronous interconnect structure that is capable of correcting the timing alignment of a data signal and a source clock signal between the first integrated circuit and the second integrated circuit each time the data signal and the source clock signal are transmitted across the synchronous interconnect structure. The synchronous interconnect structure includes a transmitter circuit having a first transmitter to transmit a source clock signal and a second transmitter to transmit a data signal synchronous to the source clock. The synchronous interconnect structure also includes a receiver circuit having a first receiver coupled to the first transmitter via a first transmission line to receive the source clock signal and a second receiver coupled to a second transmitter via a second transmission line to receive the data signal. The synchronous interconnect structure can interconnect one or more integrated circuits on one or more printed circuit boards (PCB's).

The receivers in the synchronous interconnect structure are two stage receivers where the first receiver stage conditions the received signal while the second stage performs the timing alignment of the source clock signal and the data signal. The second stage of the receivers include a deskewing circuit that performs the timing alignment and an integration sense amplifier to interpret the data signal. The deskewing circuit includes a control circuit to control an amount of propagation delay inserted into the second stage of the receiver for each internal transmission path within the receiver for the source clock signal and the data clock signal to provide the proper timing alignment. The deskewing circuit also includes a phase locked loop circuit that provides the control circuit with a feedback signal that synchronizes the amount of propagation delay inserted into each transmission path within the receiver to align the source clock signal and a data signal or to align one or more data signals.

The control circuit includes a detection circuit to determine and assert a correction signal if the amount of the propagation delay asserted into the source clock signal path or the data signal path within the receiver needs correction. The control circuit also includes a delay circuit that performs the insertion of the propagation delay into the clock signal path and each data signal path within the receiver. The detection circuit also includes a phase detector to detect a phase differential between the source clock signal and the data signal following the insertion of an amount of propagation delay into the source clock signal data path and the data signal data path within the receiver. Also included with the detection circuit is a counter that tracks the phase differential detected by the phase detector and a fault detector that detects when the data signal and the source clock signal toggle to allow the counter to properly track the phase differential determined by the phase detector.

The delay circuit includes delay elements to delay propagation of the source clock signal and the data signal along their respective transmission paths within the receiver. Also included is a finite state machine that is clocked by the phase locked loop circuit. The finite state machine interprets the correction signal asserted by the counter to control the amount of propagation delay inserted into the transmission path of the source clock signal and the transmission path of the data signal within the receiver.

The phase locked loop circuit includes a voltage controlled oscillator that generates a signal that has a frequency proportional to a control voltage asserted at an input node of the voltage controlled oscillator. A frequency multiplier multiplies the frequency output signal of the voltage controlled oscillator to provide the finite state machine with a clock signal synchronized to the source clock signal. The phase locked loop circuit also includes a phase detector to detect the phase differential between the source clock signal and the feedback signal of the voltage controlled oscillator. The phase locked loop circuit further includes a charge pump to provide a charge current to a loop filter based on the phase differential detected by the phase detector. The loop filter integrates and filters the charge current to provide the voltage controlled oscillator with the necessary control voltage signal to generate the frequency output signal.

The above-described approach benefits a system architecture that utilizes multiple microprocessors, memory arrays and other like devices that communicate in a synchronous point to point manner because a data signal can be continuously aligned to a source clock signal and to each data signal transmitted in the synchronous point to point manner. As a consequence, the synchronous interconnect structure interconnecting the various integrated circuits on a printed circuit board can continuously compensate for phase shifts that occur during data transmission in real time. Such an interconnect architecture benefits multiprocessor server systems that utilize high speed inter-chip signaling.

In accordance with another aspect of the present invention, a method is performed to align a source clock signal and a data signal in a synchronous interconnect structure between a first integrated circuit and a second integrated circuit. The method allows the synchronous interconnect structure to align the source clock signal and the data signal while the synchronous interconnect structure transports data. This ensures correct timing alignment of the source clock signal and one or more data signals for interpretation by the receiver. The method performs the timing alignment between the source clock signal and the data signal by receiving the source clock signal and the data signal and detecting a first phase offset between the source clock signal and the data signal. The method also detects a second phase offset between the source clock signal and a feedback signal provided by the receiver of the synchronous interconnect structure. Based on the first phase offset value detected, the method generates one or more delay values and based on the second phase offset value, the method synchronizes the adjustment of the propagation delay of the transmission path for the source clock signal and the propagation delay for the data signal within the receiver accordingly. The method also integrates the data signal for a period about equal to one bit period of the source clock signal following the phase detection to determine a data value for the data signal.

The method utilizes a delay locked loop structure within the receiver to generate a time varying signal based on the offset value determined between the source clock signal and the feedback signal. A counter circuit within the receiver generates a first delay value based on a sampling of the phase offset between the source clock signal and the data signal. A finite state machine receives the time varying signal generated by the delay locked loop structure and the delay value generated by the counter circuit, and adjusts the propagation delay for the source clock signal transmission path and the propagation delay for the data signal transmission path within the receiver accordingly.

The method is able to perform the timing alignment between the source clock signal and the data signal, or between one data signal and another, using either the rising or falling edges of either signal. The method can use a phase interpolator or a transmission gate to create the necessary propagation delay in each transmission path within the receiver to ensure proper timing alignment. Furthermore, the data signal transported across the synchronous interconnect structure can be a differential signal.

The above-described approach benefits a microprocessor architecture utilizing parallel printed circuit board traces as a transmission medium. Thus, the architecture maximizes the bandwidth capability of the printed circuit board transmission medium. Moreover, this approach constantly monitors each transmission path to detect and adjust for timing alignment errors that occur between the transmitter and the receiver of the synchronous interconnect structure. Thus, the effects of cross talk or variations in transmission path capacitance or impedance can be compensated for by adding or subtracting propagation delay in the receiver before a data value is determined by an integration amplifier. As a result, a data value misinterpretation by the integration amplifier is avoided.

### BRIEF DESCRIPTION OF THE DRAWINGS

An illustrative embodiment of the present invention will be described below relative to the following drawings.

FIG. 1 depicts a block diagram of a synchronous interconnect structure suitable for practicing the illustrative embodiment of the present invention.

FIG. 2 depicts a block diagram of the receiver suitable for implementing the illustrative embodiment of the present invention.

FIG. 3 is a flow diagram depicting the steps taken to practice the illustrative embodiment of the present invention.

### DETAILED DESCRIPTION

The illustrative embodiment of the present invention provides a synchronous interconnect structure to continuously align a source clock signal and a data signal or multiple data signals with each other in an electronic system that utilizes point to point communications. In the illustrative embodiment, the synchronous interconnect structure is adapted to have a receiver for receiving a source clock signal and a data signal in a manner that compensates for the propagation time within the receiver for each received signal to provide proper signal timing alignment. The receiver dynamically performs the signal timing alignment on a per bit basis to align each received data signal with the source clock signal or to other data signals. The receiver performs the signal timing alignment of the source clock signal and a data signal by determining a phase differential between the source clock signal and a feedback signal from a voltage controlled oscillator (VCO) and by determining a phase differential between the source clock signal and the data signal.

The phase differential between the source clock signal and the feedback signal of the VCO is used to tune the VCO to produce a frequency value that is then multiplied and asserted to a finite state machine. The phase differential value detected between the source clock signal and data signal is sampled by a counter circuit to track the arrival time of the source clock signal and the data signal at the receiver and provide the finite state machine with a second input value. The finite state machine adjusts delay elements in the transmission path of the data signal within the receiver and delay elements in the transmission path of the source clock signal within the receiver to align the source clock signal and the data signal. The adjustment is based on the input value from the frequency multiplier and from the input value from the counter circuit. Following the timing alignment of the source clock signal and the data signal an integration amplifier integrates the data signal for the period of the clock signal and asserts a data value representative of the data signal.

In the illustrative embodiment, the synchronous interconnect structure is attractive for use in multiprocessor interconnection networks where the multiple microprocessors communicate with each other in a source synchronous point to point manner. The synchronous interconnect structure of the illustrative embodiment is able to achieve signal timing alignment of one or more signals transmitted in parallel on a per bit basis without the need of a phase interpolator or per bit loop filter capacitors. As a result, the synchronous interconnect structure requires about the same amount of silicon surface area as conventional structures currently utilized. Moreover, the synchronous interconnect structure is dynamic because the illustrative synchronous interconnect structure can perform and achieve timing alignment while the system is operating without regard to the data pattern dependencies transmitted across the synchronous interconnect structure. Consequently, the illustrative embodiment continuously aligns the source clock signal to each data signal or one data signal to another in the source synchronous interconnect structure to compensate for phase shifts caused by dynamic events, such as cross talk, transmission path loading and capacitive and inductive effects of data transmission on the transmission lines.

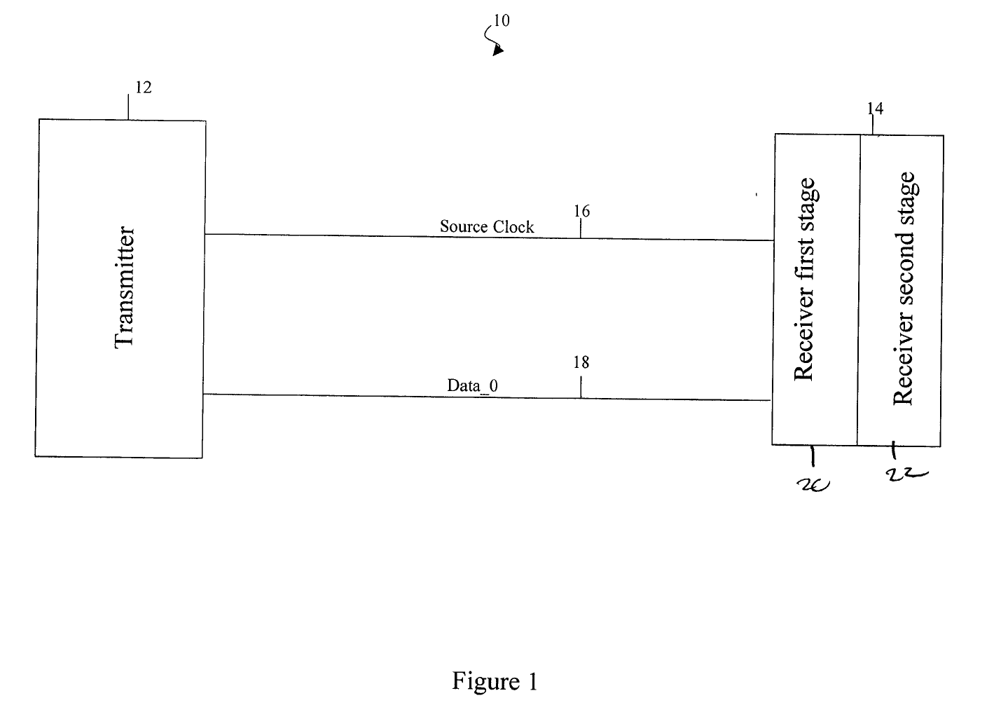

FIG. 1 illustrates an exemplary synchronous interconnect structure 10 that is suitable for the illustrative embodiment of the present invention. The exemplary source interconnect structure 10 includes a transmitter 12 coupled to a receiver 14 via the transmission line 16 and the transmission line 18. The receiver 14 includes a first receiver stage 20 and a second receiver stage 22 that are discussed in more detail below. The transmission line 16 is utilized by the transmitter 12 to transmit a source clock signal and the transmission line 18 is utilized by the transmitter 12 to transmit a data signal. Those skilled in the art will recognize that transmission line 16 and 18 are like transmission lines. Moreover, those of ordinary skill in the art will recognize that the transmitter 12 utilizes a driver element dedicated to the transmission line 16 and a driver element dedicated to the transmission line 18.

FIG. 1 illustrates a one bit source synchronous point to point interconnect structure. Nevertheless, those skilled in the art will recognize that the exemplary synchronous interconnect structure 10 may include additional transmission lines such as, 4 data transmission lines, 8 data transmission lines, 16 data transmission lines, 32 data transmission lines or 64 data transmission lines. In like manner, the exemplary synchronous interconnect structure 10 can have as few as one data transmission line.

To ease the discussion below, the receiver 14 is discussed in relation to the transmission lines 16 and 18. This is not meant to be limiting of the illustrative embodiment of the present invention, but rather is intended to facilitate explanation. Those skilled in the art will appreciate that the details discussed below apply equally to each bit transmitted by the transmitter 12.

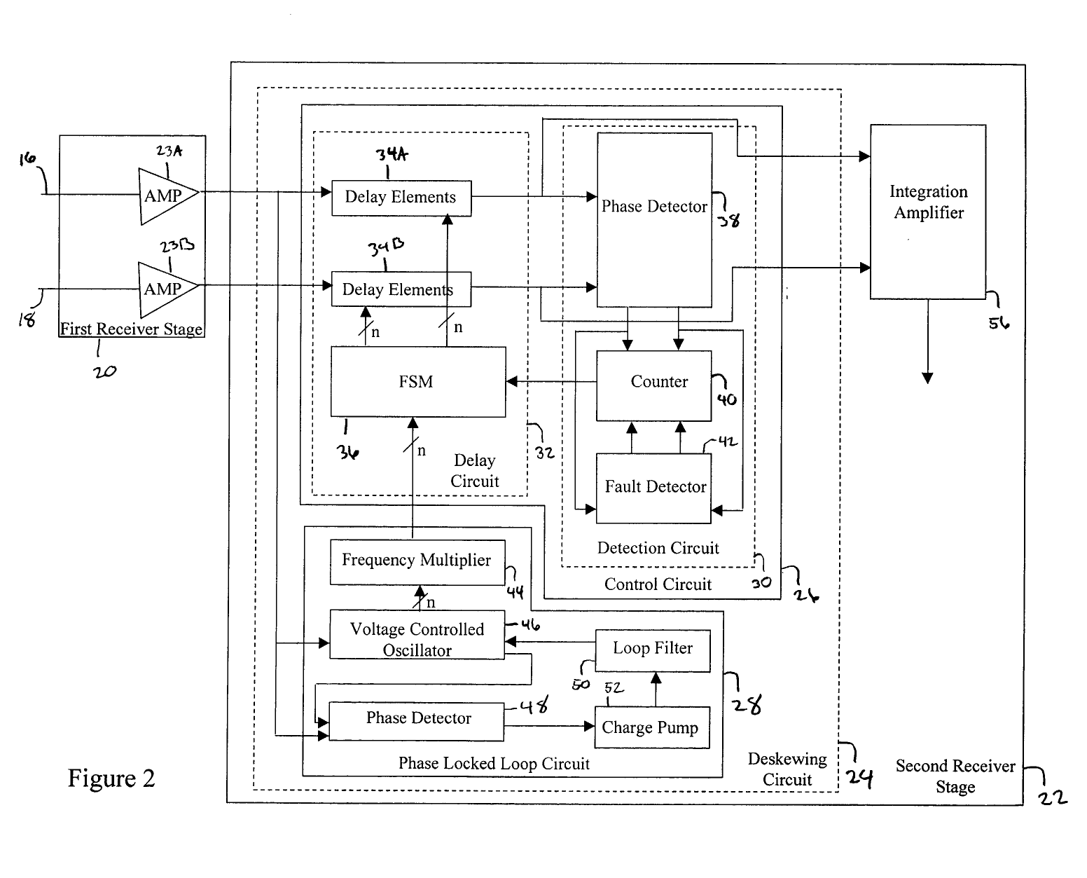

FIG. 2 illustrates the receiver 14 in more detail. The first receiver stage 20 includes amplifier 23A and 23B to condition the signal on transmission line 16 and the signal on transmission line 18, respectively. The outputs of the amplifier 23A and 23B are coupled to the second receiver stage 22. In addition, the output of the amplifier 23A is coupled to a voltage control oscillator (VCO) 46 and a phase detector 48 of a phase locked loop circuit 28.

Amplifiers 23A and 23B provide any necessary input filtering and also translate the source clock signal transmitted across the transmission line 16 and the data signal transmitted across the transmission line 18 from anywhere in the allowable input common mode range to a fixed output common mode voltage. Those skilled in the art will recognize that the first receiver stage 20 can be adapted to convert a single ended data signal into a differential signal for use by the second receiver stage 22.

The second receiver stage 22 includes a deskewing circuit 24 and an integration amplifier 56 to align the timing between the source clock signal and the data signal. The integration amplifier 56 integrates the data signal over about one bit period of the source clock signal received by the amplifier 14. Those skilled in the art will recognize that the integration amplifier 56 can be adapted to integrate data during a particular phase or both phases of the source clock provided by the transmitter 12. In this fashion, the integration amplifier 56 can determine a data value from an A phase domino circuit coupled to the exemplary synchronous interconnect structure 10 and a data value from a B phase domino circuit coupled to the exemplary synchronous interconnect structure 10 and output the corresponding data values without interruption. Those skilled in the art will recognize that an A phase domino circuit evaluates data during the A phase of the system clock, that is, when the source clock is at a logic “1” level and that the A phase domino circuit precharges its dynamic nodes when the system clock is in its B phase or at a logic “0” level. Moreover, those of ordinary skill in the art will recognize that a B phase domino circuit precharges its dynamic nodes during the A phase of the system clock and evaluates its data during the B phase of the system clock.

The deskewing circuit 24 includes a control circuit 26 and a phase locked loop circuit 28. The control circuit 26 includes a delay circuit 32 and a detection circuit 30. The phase locked loop circuit 28 includes a phase detector 48 having a first input coupled to the output of the amplifier 23A and a second input coupled to a feedback signal of the VCO 46. The output of the phase detector 48 is coupled to a charge pump 52, and the output of the charge pump 52 is coupled to a loop filter 50. The loop filter 50 has its output coupled to the VCO 46. The VCO 46 has a second input coupled to the output of the amplifier 23A and an output coupled to the frequency multiplier 44. Those skilled in the art will recognize that the VCO 46 can have multiple outputs and multiple phase output signals depending on the accuracy of phase adjustment or timing alignment desired.

The phase locked loop circuit 28 senses the source clock signal at the input to the second receiver stage 22 and adjusts its output phase signal until the phase of its output phase signal matches the phase of the source clock signal at the input of the second receiver stage 22. The output of the VCO 46 coupled to the phase detector 48 provides a negative feedback loop that adjusts the output of the VCO 46 to drive the frequency multiplier 44.

The phase detector 48, also known as a phase comparator, compares the source clock signal 16 at the input of the second receiver stage 22 and an output sample of the VCO 46 to generate an output pulse that represents the direction in magnitude of the phase difference between the source clock signal and the output of the VCO 46. Those skilled in the art will recognize that there are multiple types of phase detectors that operate in a different manner to sense their input signals, to determine what target input phase difference causes them to detect no phase error and to determine how the phase error is represented in the output pulse. For ease of the discussion below, we consider the case of phase frequency detectors. Typically, phase frequency detectors are only rising or falling edge sensitive and produce a single output pulse at either an up output or a down output depending on which signal edge arrives first at the input of the phase detector. The duration of the output pulse is about equal to the time difference between the two edges or, equivalently the input phase difference between the two signals.

The charge pump 52 coupled to the output of the phase detector 48 sources or sinks current for the duration of the output pulse from the phase detector 48. The output charge of the charge pump 52 is proportional to the pulse width of the output pulse produced by the phase detector 48. The charge pump 52 drives the loop filter 50, which integrates and filters the charge current to produce a control voltage. The control voltage from the loop filter 50 drives the VCO 46, which, in turn, generates an output signal having a frequency proportional to the control voltage asserted by the loop filter 50. The frequency multiplier 44 multiplies the frequency output and asserts the multiplied frequency to the finite state machine 36 of the delay circuit 32. Those skilled in the art will recognize that the phase locked loop circuit 28 can be replaced with a delay locked loop circuit in which case, the VCO 46 can be substituted with a voltage controlled delay line.

The detection circuit 30 includes the phase detector 38 to detect a phase differential between the source clock signal and the data signal at the output of the delay elements 34A and the delay elements 34B, respectively. The phase detector 38 compares these two input signals and generates two output pulses commonly referred to in the art as “UP” and “DN”. As discussed above, the phase detector 38 can be configured in a number of ways to sample the phase differential, but for simplicity in facilitating explanation of the illustrative embodiment of the present invention, the phase detector 38 is configured to be either rising or falling edge sensitive. For each pair of input signals, the phase detector 38 produces a single output pulse at either the “UP” output or “DN” output to drive the counter 40. Which output the phase detector 38 asserts depends on which signal edge, the source clock signal or the data signal, arrives first. The duration of the output pulse asserted by the phase detector 38 is about approximately equal to the time difference between the two edges of the input signals. For example, if the rising edge of the source clock arrives at the input of the phase detector 38 before the rising edge of the data signal at the second input of the phase detector 38, the phase detector 38 asserts at the “UP” output node with a pulse having a period approximately equal to the time difference between the rising edge of the source clock and the rising edge of the data signal.

The counter 40 is configured as an up down counter to track the number of “UP” and “DN” pulses asserted by the phase detector 38. After a number of samples, the counter 40 determines whether the delay in the delay elements 34A or 34B need to be updated and in which direction. In more detail, the counter 40, depending on which line is asserted by the phase detector 38 counts up or down. Typically, the counter 40 generates a phase direction output signal for use by the finite state machine 36 to adjust the delay elements 34A or 34B to more closely align the rising or falling edge of the source clock with the rising or falling edge of the data signal.

To prevent a false count by the counter 40, the fault detector 42 also receives the output pulses of the phase detector 38 and determines from the period of the phase detector output pulse whether the counter 40 should keep or discard the sample value. The fault detector 42 determines if the period of the phase detector output pulse is less than or greater than the period of the source clock signal transmitted on the transmission line 16. In this manner, if the period of the output pulse from the phase detector 38 is less than the period of the source clock signal, the fault detector 42 indicates to the counter 40 that the count sample is valid. If the fault detector 42 detects that the period of the output pulse from the phase detector 38 is greater than the period of the source clock signal, the fault detector 42 instructs the counter 40 that the count sample is invalid. The counter 40 ignores or discards all invalid count samples.

As a result, a data pulse having a period lasting longer than the period of the source clock signal can be ignored to avoid either over or under propagation delay compensation for the extended data period within the exemplary synchronous interconnect structure 10. Moreover, using this technique, the exemplary synchronous interconnect structure 10 is able to detect a stuck at bit and report the detected fault.

The delay circuit 32 receives the frequency value generated by the phase locked loop circuit 28 and the phase direction output signal generated by the detection circuit 30 at the finite state machine 36. The operation of the finite state machine 36 is synchronized by the time varying the signal asserted by the phase locked loop circuit 28. The finite state machine 36 interprets the value asserted by the detection circuit 30 and determines if the delay elements 34A or 34B need to be adjusted to align the source clock signal and the data signal transmitted over the transmission line 16 and the transmission line 18, respectively. The delay elements 34A and 34B can be either a transmission gate delay circuit or a phase interpolator that adds or removes propagation delay to the clock and data transmission paths within the second receiver stage 22.

The value asserted by the detection circuit 30 indicates to the finite state machine 36 which transmission path within the second receiver stage 22 needs to be adjusted and how much propagation delay needs to be added or subtracted to align the source clock signal 16 and the data signal 18 within the second stage of the receiver 22. Moreover, the finite state machine 36 utilizes the frequency value of the time varying signal generated by the phase locked loop circuit 28 to synchronously assert its output with the state transition to adjust the delay elements 34A and 34B with an edge of the source clock signal 16. In this manner, any updates to the delay elements 34A and 34B are synchronized with the receiving of the source clock signal 16 and the data signal 18 to minimize data latency through the exemplary synchronous interconnect structure 10. Nonetheless, those skilled in the art will recognize that the finite state machine 26 can be adapted to have an asynchronous output that can change in response to any changes in the frequency value generated by the phase locked loop circuit 28 or the phase direction output signal generated by the detection circuit 10.

The second receiver stage 22 facilitates high speed data transmission between multiple microprocessors, memory arrays and other like devices in that the deskewing of a source clock signal and each transmitted data bit occurs automatically with each data transmission. In this manner, dynamic events, such as cross talk or capacitive loading or unloading of the transmission path can be compensated for in real time without having to slow either the rate of data transmission or the data processing rate of the circuits involved. Moreover, the second receiver stage 22 is able to detect whether the transmitter 12 has an output shorted to ground, to another output pin, or to the power rail.

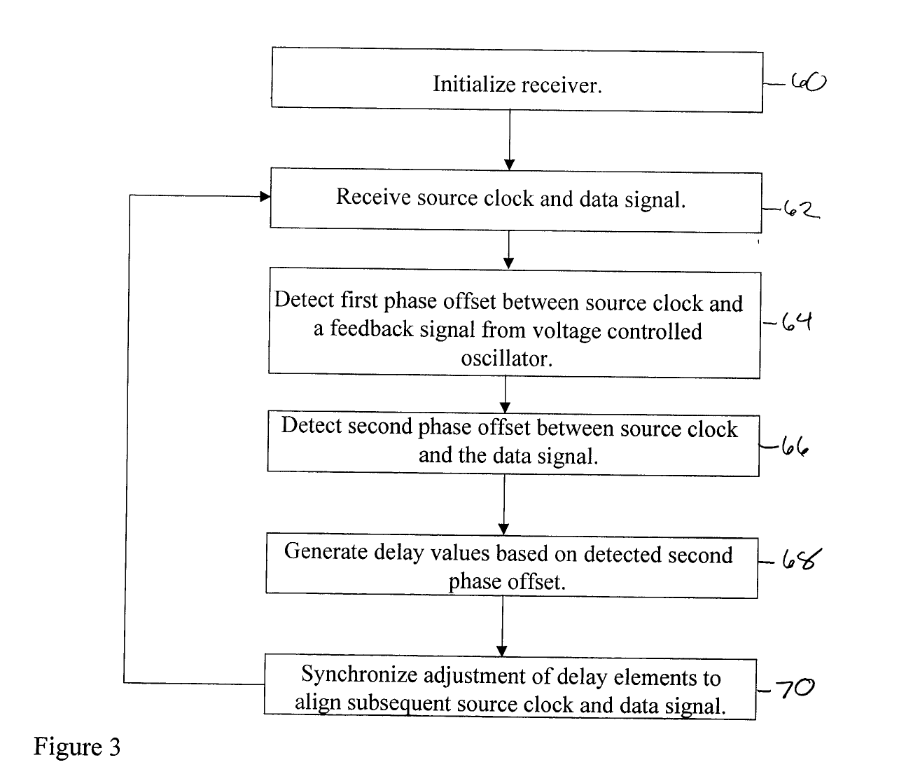

FIG. 3 illustrates the steps taken by the exemplary synchronous interconnect structure 10 to align a source clock signal and one or more data signals. Upon power up or initiation of a reset command, the exemplary synchronous interconnect structure 10 initializes the receiver 14. To initialize the receiver 14, the transmitter 12 transmits test data along the transmission line 18 and the source clock signal along the transmission line 16 to the receiver 14 (step 60). In this manner, fixed factors that cause signal timing alignment discrepancies, such as variation in length of transmission lines for each transmitted signal can be measured and compensated for. Those skilled in the art will recognize that the transmitter 12 can transmit multiple test data sets in order for the receiver 14 to properly initialize and set the proper delay value in the delay elements 34A and 34B.

Once the receiver 14 is initialized, the exemplary synchronous interconnect structure 10 is set to transmit and receive data in a synchronous point to point manner and thereafter compensate for any signal timing alignment issues that occur in real time fashion. The receiver 14 receives from the transmitter 12 a source clock signal on the transmission line 16 and a data signal on the transmission line 18 to determine a data value using the integration amplifier 56 (step 62). The first receiver stage 20 conditions the received source clock signal and the received data signal and passes each conditioned signal to the second receiver stage 22. At the second receiver stage 22 the phase locked loop circuit 28 detects any phase offset between the source clock signal and a feedback signal from the VCO 46 (step 64). As discussed above, the VCO 46 adjusts its output frequency in accordance with any phase offset detected by the phase detector 48. Once the source clock signal and the data signal propagate through the delay elements 34A and 34B respectively, the detection circuit 30 examines the source clock signal and the data signal to detect any phase offset between the two signals (step 66).

If the detection circuit 30 detects an offset after a number of samples, the detection circuit 30 asserts an offset direction value to the finite state machine 36 that indicates whether the delay elements 34A or the delay elements 34B need to be adjusted to add or subtract propagation delay from the data path for either the source clock signal or the data signal within the receiver 14 (step 68). In addition, the phase locked loop circuit 28 also provides the finite state machine 36 with a time varying signal having a frequency value synchronous with the source clock signal to allow the finite state machine 36 to adjust the delay elements 34A and 34B in unison with a rising or falling edge of the source clock signal. The finite state machine 36 adjusts the delay elements 34A and 34B in accordance with the value asserted by the detection circuit 30 to align either the rising or falling edge of the source clock signal with either the rising or falling edge of the data signal (step 70).

Those skilled in the art will recognize that the exemplary synchronous interconnect structure 10 performs the above-described signal timing alignment on a per bit basis. While the present invention has been described with reference to a preferred embodiment thereof, one skilled in the art will appreciate that various changes in form and detail may be made without departing from the intended scope of the present invention as defined in the pending claims. For example, the source synchronous interconnect structure 10 may be adapted to transmit and receive multilevel source synchronous signals, such as a two level pulse amplitude modulation (2-PAM) signal or a four level pulse amplitude modulation (4-PAM) signal.

What is claimed is:

1. A system for synchronous communication between a first integrated circuit and a second integrated circuit comprising:
a synchronous interconnect structure for correcting timing alignment of a data signal and a source clock signal between said first integrated circuit and said second integrated circuit each time said data signal and said source clock signal are transmitted across said synchronous interconnect structure.

2. The system of claim 1, wherein said synchronous interconnect structure comprises, a deskewing circuit for connecting said timing alignment between said data signal and said source clock signal.

3. The system of claim 1, wherein said synchronous interconnect structure further comprises:
a transmitter circuit comprising a first transmitter and a second transmitter wherein said first transmitter asserts said source clock signal and said second transmitter asserts said data signal;
a receiver circuit comprising a first receiver and a second receiver wherein said first receiver receives said source clock signal asserted by said first transmitter and said second receiver receives said data signal asserted by said second transmitter; and
a first transmission line and a second transmission line, wherein said first transmission line interconnects said first transmitter and said first receiver and said second transmission line interconnects said second transmitter and said second receiver.

4. The system of claim 3, wherein said first receiver and said second receiver each comprise a first receiver stage and a second receiver stage.

5. The system of claim 4, wherein said first receiver stage of said first receiver and said first receiver stage of said second receiver each comprise a signal conditioner to translate a received signal to a fixed output common-mode voltage.

6. The system of claim 4, wherein said second receiver stage of said first receiver and said second receiver stage of said second receiver comprises:
an integration sense amplifier to integrate and sense a value of said data signal after said correction of said timing alignment by said deskewing circuit.

7. The system of claim 2, wherein said deskewing circuit comprises:
a control circuit to control an amount of propagation delay inserted into a first transmission path within said deskewing circuit on which said data signal propagates and an amount of propagation delay inserted into a second transmission path within said deskewing circuit on which said source clock signal propagates, wherein the amount of propagation delay inserted into said first transmission path can have a value different from the amount of propagation delay inserted into said second transmission path; and
a phase-locked loop circuit to provide said control circuit with a output signal that indicates when the amount of said propagation delay should be inserted into said first and said second transmission path.

8. The system circuit of claim 7, wherein said control circuit comprises:
a detection circuit to determine and assert a correction signal if the amount of said propagation delay inserted into said first and said second transmission path needs adjustment; and
a delay circuit that inserts said propagation delay into said first and said second transmission path based on said input signal asserted by said phase-locked loop circuit and said correction signal asserted by said detection circuit.

9. The system of claim 8, wherein said detection circuit comprises:
a phase detector to detect a phase differential between said source clock signal and said data signal following the insertion of said propagation delay into said first and said second transmission path;
a counter to track the phase differential determined by said phase detector and assert said correction signal that indicates which direction said timing alignment should shift; and
a fault detector to detect when said data signal and said source clock signal toggle to allow said counter to track said phase differential when said data signal and said source clock signal both toggle.

10. The system of claim 8, wherein said delay circuit comprises,
a first delay element to insert said propagation delay into said first transmission path within said receiver;
a second delay element to insert said propagation delay into said second transmission path within said receiver; and
a finite state machine to interpret said correction signal asserted by said counter to control an amount of said propagation delay inserted into said first and second transmission path by said delay circuit.

11. The system of claim 7, wherein said phase-locked loop circuit comprises,
a voltage controlled oscillator (VCO) to generate said output signal, wherein said output signal has a frequency value proportional to a control voltage asserted at an input node of said voltage controlled oscillator;
a frequency multiplier to multiply the frequency value of said output signal asserted by the voltage controlled oscillator to provide said control circuit with a time varying signal synchronized to said source clock signal; phase detector to detect a phase difference between said source clock signal and a feedback signal from said voltage controlled oscillator;
a charge pump to provide a charge current based on said phase difference detected by said phase detector; and
a loop filter to integrate and filter said charge current to drive said voltage controlled oscillator with said control voltage.

12. The system of claim 1, wherein said first integrated circuit and said second integrated circuit comprises a very large scale integration (VLSI) circuit.

13. The system of claim 1, wherein said first integrated circuit and said second integrated circuit comprises a microprocessor.

14. The system of claim 7, wherein said phase-locked loop circuit comprises a delay locked-loop circuit.

15. The system of claim 14, wherein said delay locked loop circuit comprises a voltage-controlled delay line (VCDL) to generate an output signal having a frequency value proportional to said control voltage asserted by said loop filter.

16. The system of claim 1, wherein said first integrated circuit and said second integrated circuit are mounted to a printed circuit board. (PCB).

17. The system of claim 1, wherein said first integrated circuit is mounted to a first circuit board and said second integrated circuit is mounted to a second printed circuit board.

18. A method for aligning a source clock signal and a data signal in a system having a synchronous interconnect structure between a first integrated circuit and a second integrated circuit while said synchronous interconnect structure transports data within said system, said method comprising the steps of receiving said source clock signal and said data signal at a receiver of said synchronous interconnect structure;
detecting a first phase offset between said source clock signal and a feedback signal at said receiver;
detecting a second phase offset between said source clock signal and said data signal at said receiver;
generating a time varying signal based on said first phase offset;
generating one or more delay values based on said second phase offset; and
adjusting in synchronization with said time varying signal a first propagation delay element within said receiver for said source clock signal and a second propagation delay element within said receiver for said data signal based on said one or more delay values to align a subsequent source clock signal and a subsequent data signal.

19. The method of claim 18, further comprising the step of, integrating said source clock signal and said data signal to determine a data value for said data signal.

20. The method of claim 18, wherein a delay-locked loop circuit within said receiver generates said time varying signal based on a value of said first phase offset.

21. The method of claim 18, wherein a counter circuit within said receiver generates a first of said one or more delay values based on a sampling of said second phase offset.

22. The method of claim 18, wherein a finite state machine performs said step of adjusting in synchronization with said time varying signal said first propagation delay element for said source clock signal and said second propagation delay element for said data signal within said receiver based on said one or more delay values to align said source clock signal and said data signal.

23. The method of claim 18, wherein said first phase offset and said second phase offset are detected using a rising edge of said source clock signal and a rising edge of said data signal.

24. The method of claim 18, wherein said first phase offset and said second phase offset are detected using a falling edge of said source clock signal and a falling edge of said data signal.

25. The method of claim 18, wherein said first and said second propagation delay element comprise one of a phase interpolator and a transmission gate.

26. The method of claim 18, wherein said data signal comprises a differential signal.

27. The method of claim 18, wherein said synchronous interconnect structure comprises a multiprocessor interconnection network within said system.

28. A deskewing circuit to perform timing alignment of a synchronous point-to-point signal on a per signal basis comprising,
a control circuit to control said timing alignment of said synchronous point-to-point signal; and
a phase locked loop circuit to synchronize said timing alignment of said synchronous point-to-point signal within said control circuit.

29. The deskewing circuit of claim 28, wherein said control circuit comprises,
a detection circuit to detect a phase differential between a first data signal of said synchronous point-to-point signal and a source clock-signal of said synchronous point-to point signal; and
a delay circuit to perform said timing alignment of said first data signal and said source door signal based on an output signal of said detection circuit.

30. The deskewing circuit of claim 29, wherein said delay circuit performs said timing alignment by adjusting a first propagation delay circuit coupled to a first transmission path within said deskewing circuit by a first propagation delay value and adjusting a second propagation delay circuit coupled to a second transmission path within said deskewing circuit by a second propagation value, wherein said first transmission path transports said source clock signal and said second transmission path transports said first data signal.

31. The deskewing circuit of claim 29, said detection circuit comprising,
a counter circuit to count an occurrence of said phase differential and assert said output signal after a predetermined count; and
a fault detector circuit to detect a false count by said counter circuit, wherein upon detection of said false count said fault detector circuit instructs said counter circuit to disregard said false count.

32. The deskewing circuit of claim 28, wherein said phase locked loop circuit synchronizes said timing alignment by asserting a time dependent signal aligned to said source clock signal to synchronize operation of said delay circuit.
